(19) United States
(12) Patent Application Publication
(10) Pub. No.: US 2013/0001231 A1
(43) Pub. Date: Jan. 3, 2013

(54) FUEL TANK

(76) Inventor: Rostislav Noskov, Kaliningrad (RU)

(21) Appl. No.: 13/583,208

(22) PCT Filed: Mar. 9, 2010
(86) PCT No.: PCT/IB2010/000487

§ 371 Date: Sep. 6, 2012

(51) Int. Cl. B60K 15/03

(52) U.S. Cl. 220/564

(57) ABSTRACT

A fuel tank with an elastic partition having the same circumference and shape of the fuel tank in which the tank is divided into two chambers, a fuel chamber and an upper fuel chamber. The circumference of the upper fuel chamber is divided into individual sealed, vertically oriented small chambers. Each small chamber is equipped with a separate overpressure supply line and a separate overpressure relief line. Each small chamber is connected to a control unit.

### CROSS-REFERENCE TO RELATED APPLICATION

This application claims the benefit of the priority filing date in PCT/IB2010/000487 and referenced in WIPO Publication No. WO/2011/110881. The earliest priority date claimed is Mar. 9, 2010.

### FEDERALLY SPONSORED RESEARCH

None

### SEQUENCE LISTING OR PROGRAM

None

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention relates to a fuel tank as defined by the preamble to claim 1.

The invention can be used in motor vehicle construction, specifically in the construction of a fuel tank.

From Russian patent disclosure RU 2301180, a device for storing and pumping liquid components is known. The device has a frame, with a tank aeration system mounted on it and with a fuel tank for fuel and oxidant, including a housing and an inner elastic diaphragm. The diaphragm is provided with a spiral stiffening element and is connected to the housing of the fuel tank.

The disadvantages of the known device include fluctuations from wave action in the fuel in the fuel tank, which cause static electricity to build up. Its other shortcomings include a periodic shifting of fuel in the tank. As a result, the location of the center of gravity of the fuel shifts as well. This can have adverse effects and must be taken into account in developing the structural embodiment and in operation.

From Russian patent disclosure RU 2005633, a fuel tank for motor vehicles is known which has a flexible sheath disposed in its chamber and a fill nozzle disposed in the upper part of the tank. The fill nozzle is provided with a sealing element that has sealing rings. The flexible sheath is embodied such that its surface area exceeds the surface area of the walls in the tank chamber. The surface of the flexible sheath is embodied in undulating or perforated fashion.

The functional possibilities of this described fuel tank include suppressing the fluctuations of the liquid fuel inside the tank. However, this version does not preclude motion of the fuel in the tank. That impairs the stability of the vehicle in cornering, i.e., going around a corner or along a curve in the road.

From the prior art (RU 2116495), a carburetor motor is known which has a reciprocating piston and a fuel tank with a fuel chamber and an upper fuel chamber. By means of a pipeline, the fuel chamber is connected to a mixture preparation system. The upper fuel chamber is provided with a line for delivering overpressure. The inlet opening of this line is connected to a cylinder work chamber. An elastic diaphragm, whose circumference and shape match those of the fuel tank, is built into the fuel tank. The diaphragm divides the tank chamber into a fuel chamber and an upper fuel chamber disposed above it.

This known technical embodiment precludes neither fuel fluctuations nor motions in the fuel tank under the influence of centrifugal forces in vehicle maneuvers. This means a reduction in the stability of the vehicle on the road. Moreover, the fluctuations from wave action in the fuel, which increase as the tank is emptied, cause static electricity to be stored up.

It is the object of the invention to increase the stability of the vehicle during cornering.

This object is attained by the features of claim 1.

### SUMMARY

The requisite technical outcome in a known fuel tank is achieved in the following manner:

The fuel tank contains an elastic (horizontal) partition. The elastic partition has the same shape and circumference as the fuel tank and divides the fuel tank into two chambers, a fuel chamber and an upper fuel chamber. The fuel chamber and the upper fuel chamber can vary mutually in their circumferences. The fuel chamber is provided with a fill nozzle. The upper fuel chamber is provided with a line for delivering overpressure. According to the invention, it is proposed that the circumference of the upper fuel chamber be divided up into individual sealed, vertically oriented small chambers. It is also proposed that each such small chamber be provided with a separate overpressure supply line and overpressure relief line and that it be connected to a control unit.

The invention will be described in further detail in terms of an exemplary embodiment shown in the drawing.

The fuel tank of the vehicle that goes around a corner or a curve in the road is 50% filled with fuel. The center of gravity of the tank is disposed off-center from the center point.

### DRAWINGS

FIG. 1 illustrates a fuel tank with the following reference numerals:

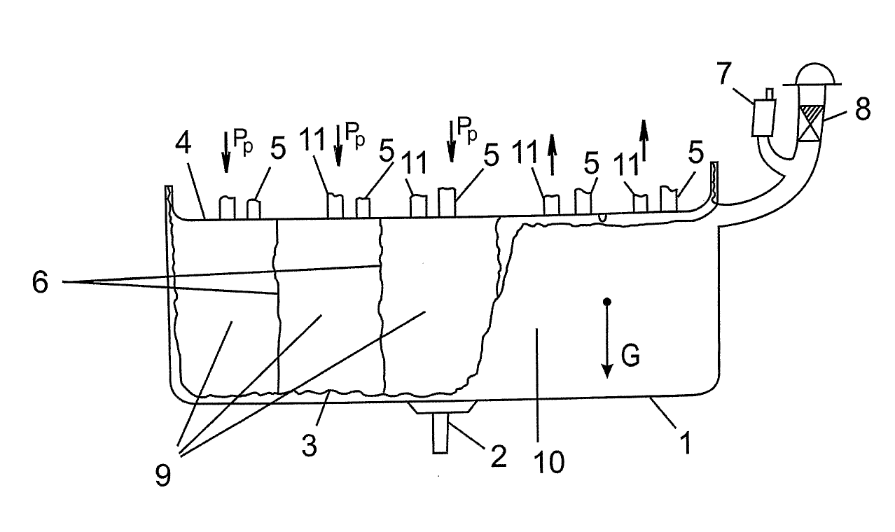

1—tank housing,

2—inlet opening,

3—elastic partition,

4—tank cap,

5—lines for overpressure delivery,

6—divider element in the upper fuel chamber,

7—float valve for blowing off gas form the liquid chamber in the tank,

8—fill nozzle with a nonreturn valve,

9—separate small chambers of the upper fuel chamber,

10—fuel chamber,

11—pressure relief line,

Pₚ—working gas overpressure required for shifting the fuel and for reducing fuel evaporation losses,

Pₐ—working gas pressure, which is equal to the atmospheric pressure, and

G—center of gravity of the fuel.

### DETAILED DESCRIPTION OF THE DRAWINGS

The proposed fuel tank comprises a housing 1, which is disposed along with a removal device 2 in its lower part and is divided by means of an elastic partition 3 into an upper fuel chamber and a fuel chamber 10. The shape of the elastic partition 3 is embodied as a container that is open at the top. The shape and circumference of the container are equivalent to those of the tank housing. The elastic partition 3 is secured in airtight fashion, for instance at the edge of a cap 4. The upper fuel chamber defined by the elastic partition 3 is divided into separate sealed small chambers 9. Lines 5 for delivering overpressure and for rapid pressure relief 11 are disposed on the cap 4 of the tank. Each small chamber 9 of the upper fuel chamber is provided with a separate supply line 5 and relief line 11 for the overpressure. The small chamber 9 is coupled via a regulating device to a control unit (not shown in the drawing). The fuel chamber 10 of the tank is equipped with a float valve 7 for an inlet for the fuel vapors.

The function of the proposed technical embodiment is as follows:

When the vehicle moves in a straight line, the load on the wheels is distributed evenly. In cornering, the fuel in the tank is shifted under the influence of centrifugal forces. This causes a shift in the center of gravity of the vehicle and consequently a redistribution of the loads on the wheels. The wheels driving on the radius of the inner turning circle are less heavily loaded.

The load on the wheels in the radius of the outer turning circle increases. This kind of redistribution of the loads reduces the stability of the vehicle on the road. When the proposed technical embodiment is used, the stability of the vehicle in cornering is increased by means of a redistribution of the mutually varying circumferences of the fuel chamber 10 and the upper fuel chamber. Not only is the reduction in the stability of the vehicle on entering a curve on the road averted in advance, but the stability of the vehicle is increased. To do so, the appropriate command for changing the fuel motion in the tank is issued by the control unit.

If the vehicle begins to turn right, for instance, the fuel in the fuel tank shifts to the left under the influence of centrifugal forces. At that moment, the control unit issues a command to move the fuel to the right-hand side of the tank. This leads to a shift in the center of gravity of the fuel tank. That, in turn, leads to an increase in the load on the wheels that travel along the radius of the inner turning circle. If the vehicle turns left, then the fuel shifts into the left-hand part of the tank.

An effect of this kind is achieved as follows:

When the motor starts, the control unit issues a command to fill all the separate sealed, vertically oriented small chambers 9 of the upper fuel chamber with working gas, for instance, with air from the compressor. The filling is effected via working gas supply lines 5, by setting an increased working air pressure Pₚ. If it becomes necessary, for example, to shift the fuel's center of gravity in the tank to the right, then a command is issued via the control unit to reduce the pressure in the small chambers 9 of the upper fuel chamber via the working air relief lines 11 disposed to the right of the center point. In the process, the pressure in the relief lines is reduced to atmospheric pressure Pₐ. The small chambers 9 of the upper fuel chamber, on the left-hand side, that have remained at overpressure Pₚ would also take on the shape of the entire chamber. Thus, the fuel and its center of gravity shifts in the required direction.

The overpressure Pₚ of the fuel in the tank makes it possible to reduce fuel evaporation losses. The fuel chamber is defined in the tank by the tank walls and the elastic partition 3. The fuel contained in this fuel tank 10 stops sloshing when the vehicle is in motion. This makes it possible to ameliorate the adverse effect of storing up static electricity.

1. A fuel tank having an elastic partition (3), which lines the fuel tank and divides it into a fuel chamber (10) and an upper fuel chamber with mutually variable circumferences, the fuel chamber (10) being provided with a fill nozzle (8) and the upper fuel chamber (9) being provided with a line (5) for delivering overpressure, wherein
the circumference of the upper fuel chamber is divided into individual sealed, vertically oriented small chambers (9).

2. The fuel tank according to claim 1, wherein the partition has the same shape and the same circumference as the fuel tank, wherein
each small chamber (9) is provided with a separate overpressure supply line (5) and a separate overpressure relief line (11), and wherein each small chamber (9) is connected to a control unit.
